(19) United States
(12) Patent Application Publication
(10) Pub. No.: US 2025/0368166 A1
(43) Pub. Date: Dec. 4, 2025

(54) HYDRO DEFROST

(71) Applicant: Muhammad Haseeb, Wayne, NJ (US)

(72) Inventor: Muhammad Haseeb, Wayne, NJ (US)

(21) Appl. No.: 18/731,721

(22) Filed: Jun. 3, 2024

(51) Int. Cl. B60S 3/04

(52) U.S. Cl. CPC B60S 3/045

(57) ABSTRACT

A handheld lightweight portable windshield defroster device that uses lukewarm or even room temperature water to quickly and efficiently melt ice that has accumulated on the windshield of an automobile. The windshield defroster device of the invention is comprised of a main substantially globular body that holds the water with an opening at the top end of the body and a lid that screws on tight over the opening to prevent the water inside the main body from spilling out. A sturdy handle attached to the top of the lid assists in moving the main body containing the water over the windshield and the heat of the water inside the main body melts the ice on the windshield within a matter of minutes.

### CROSS REFERENCE TO RELATED APPLICATION

This application claims priority under 35 USC 119 (e) to U.S. Provisional Patent Application Titled: CLOTH WATER BAG ICE DEFROSTER FOR AUTOMOBILE WINDSHIELDS, Ser. No. 63/510,164 with a filing date of Jun. 26, 2023 which is incorporated herein, in its entirety.

### FIELD OF THE INVENTION

This invention generally relates to methods and devices used for automobile maintenance. More particularly, the invention relates to a device for defrosting automobile windshields

### BACKGROUND OF THE INVENTION

In parts of the country where there is heavy snow accumulation in the winter time, automobiles parked outside the confines of a garage, carport or, other protective structure, accumulate a significant amount of snow and underlying ice on their windshields which if not removed before the vehicle is driven, will obscure the forward view of the driver, potentially leading to accidents. Although, the top parts of the accumulated snow on the windshield can be removed by brushing the layers off, the remaining snow which forms a sheet of ice on the windshield can be removed only by laborious scraping with an ice scraper which may not remove all the ice, and may even damage the windshield glass. Although the built-in defrosters within the vehicles when activated accomplish the task of melting the remaining ice on the windshields, the process generally takes some time before the ice is completely melted to allow the driver to start driving the vehicle.

Some prior art describe automobile windshield defrosters that are not built into the structure of the vehicles by their manufacturers which more or less accomplish the task of defrosting the automobile windshields. U.S. Pat. No. 9,603,200 to Bennett describes a device that sits on the exterior side of a windshield and melts snow and ice that has accumulated on the windshield. The windshield defroster of this invention has to be powered either through the automobile's electrical system or through solar panels. U.S. Pat. No. 5,844,202 to Alverson describes a portable defroster that has to be activated by an operator settable timing device which requires the use of the vehicles power. The car window defroster in U.S. Pat. No. 4,404,705 to Thoma suggests using the waste heat escaping through the exhaust pipe of the automobile for defrosting the front and back windows. The portable automobile window defrosters claimed in these prior art are cumbersome devices requiring significant assembly and dismantling after they accomplish the task of defrosting automobile windows. The present invention is a simple, portable, handheld mechanical device that accomplishes the task of defrosting the windshield of a vehicle fast and efficiently without complicated assembly and dismantling of the device after it accomplishes the task of defrosting the automobile windows.

### SUMMARY OF THE INVENTION

It is, an object of the present invention to provide a simple one-piece, handheld, portable mechanical device that accomplishes the task of removing the accumulated ice on an automobile windshield easily and efficiently within a short period of time using just lukewarm or room temperature water.

It is another object of the present invention to provide a light weight, portable device that can be carried within a vehicle to defrost the windshield of the vehicle.

It is another object of the present invention to provide a windshield defroster device that effectively removes the accumulated ice on the windshield of an automobile without damaging the windshield of the vehicle.

In accordance with the described main objects of the present invention, the exemplary embodiment of the device of the invention is comprised of a substantially globular main body composed of a cotton or other soft and durable material with an opening at one end much like a bottle mouth that has spiraling threads inside the mouth capable of aligning with the screw arrangement at the bottom of a lid having a handle, to close the mouth of the device tightly to prevent the water held within the main body from spilling out when the device is being used to defrost the windshield of the vehicle.

In another embodiment of the present invention, the main body of the windshield defroster can be attached to an extended handle to allow holding the body of the defroster with the extended handle and move the body of the device holding the water over the windshield to defrost the windshield.

In yet another embodiment of the present invention, a handle attached to the main body of the device can be configured with an ice scraper at the free end of the handle.

The foregoing summary of the present invention and its embodiments should not be construed to limit the scope of the invention. In this summary of the invention and in the specification in general references to the embodiments of the invention as, “the exemplary embodiment,” and all such related references to embodiments of the invention do not necessarily refer to the same embodiment(s). Rather, these references to the various embodiments in general mean that a particular feature, structure, or characteristic described in conjunction with an embodiment is included in at least some embodiments, but not necessarily all embodiments of the invention. The objects, embodiments, and features of the present invention as described in this summary of the invention will be further appreciated and will become obvious to one skilled in the art when viewed in conjunction with the accompanying drawings, detailed description of the invention, and the appended claims.

### BRIEF DESCRIPTION OF THE DRAWINGS

FIG. 1 is a perspective view of the device of the invention.

FIG. 2 is a top plan view of the device of the invention.

FIG. 3 is another perspective view of the device of the invention.

### DETAILED DESCRIPTION FO THE INVENTION

The present invention is a portable windshield defroster device that uses lukewarm or room temperature water to defrost the windshields of automobiles.

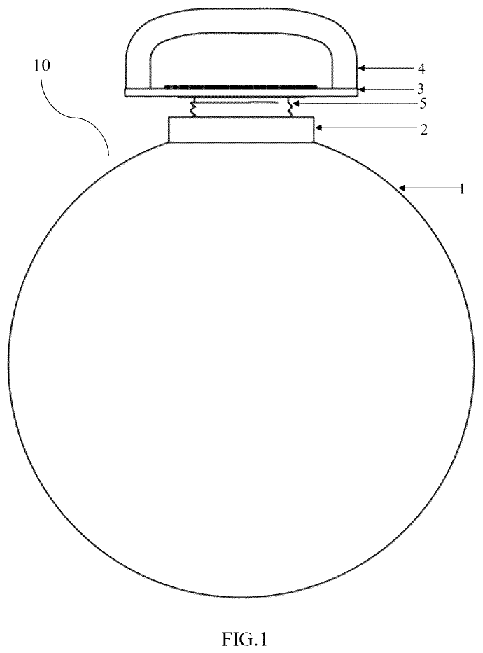

Referring now to the Figures wherein like numerals represent like elements in the various views presented, and referring in particular to FIG. 1 which shows a perspective view of the Hydro Defrost 10 of the present invention. The Hydro Defrost 10 is comprised of a substantially globe shaped main body 1 to hold the water which facilitates the melting of the ice on the automobile windshield. The main body 1 of the Hydro Defrost 10 is made of a soft, pliable, waterproof material that allows the water held in the main body 1 of the Hydro Defrost 10 to transfer the heat from the water to the surface of the automobile windshield to melt the ice on the windshield. The top end of the main body 1 of the Hydro Defrost 10 is configured with an opening 2 to allow the main body 1 to be filled with lukewarm or room temperature water. The opening 2 of the main body 1 of the Hydro Defrost 10 is closed with a lid 3 which is attached to a handle 4 at the top end of the main body 1. A screw-type arrangement 5 at the bottom end of the lid 3 aligns with the spiraling threads inside the mouth of the opening 2 of the main body 1 to close the lid 3 tightly over the mouth of the main body 1 to prevent the water held inside the main body 1 from spilling out when gliding the main body 1 holding the water over the automobile windshield. The handle 4 made of durable material is capable of withstanding force applied to it when pressing down on the main body 1 while moving the main body 1 over the length of the windshield to melt the ice accumulated on the automobile windshield in a very short period of time and within a matter of minutes.

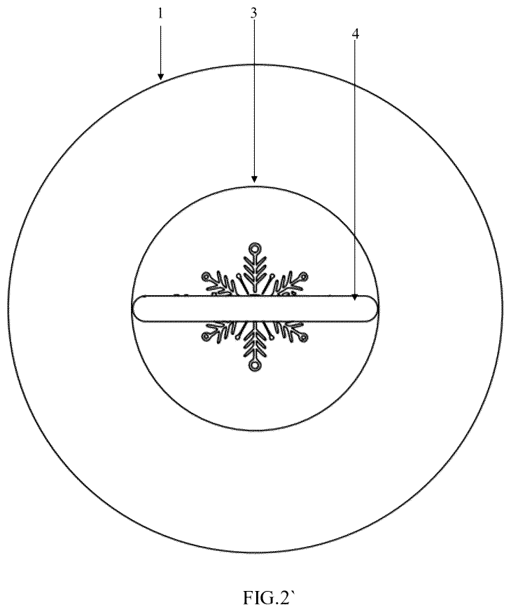

FIG. 2 is a top plan view of the device of the Hydro Defrost 10 with the main body 1, the lid 3 and the handle 4.

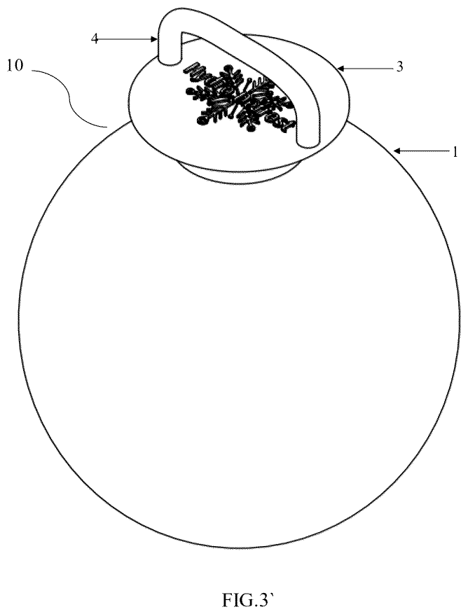

FIG. 3 is another perspective view of the Hydro Defrost 10 showing the main body 1 the lid 3 and the handle 4.

The foregoing description of the invention through its figures and preferred embodiment(s) should not be construed to limit the scope of the invention. It is to be understood that the embodiment(s) of the present invention as described herein do not limit any application or scope of the invention and that the invention can be carried out and practiced in various ways and implemented in embodiments other than the ones outlined in the description above. It should be understood and obvious to one skilled in the art that alternatives, modifications, and variations of the embodiments of the present invention may be construed as being within the spirit and scope of the appended claims.

What is claimed is:

1. A portable handheld windshield defroster device comprising:
a) a substantially globular main body having an opening at a top end;
b) a lid to close said opening at said top end of said substantially globular main body of said portable handheld windshield defroster device;
c) a handle for holding said main body of said windshield wiper device;
wherein said substantially globular main body of said portable handheld windshield defroster device capable of holding water;
wherein said opening at said top end of said substantially globular main body of said portable handheld windshield defroster device is akin to a bottle mouth having a spiral threading construction within said opening of said globular main body;
wherein said lid having a screw type construction at a bottom end of said lid;
wherein said screw type construction at said bottom end of said lid aligns with said spiral threading construction within said opening at said top end of said substantially globular main body of said portable windshield defroster device to close said opening of said main body of said device; and
said handle attached to a top end of said lid to hold said portable handheld windshield defroster device.

2. The portable handheld wind shield defroster device of claim 1 wherein, said substantially globular main body of said device is constructed from waterproof material to prevent leakage of water held within said main body of the device.

3. The portable handheld wind shield defroster device of claim 1 wherein, said substantially globular main body of said device holds lukewarm water.

4. The portable handheld wind shield defroster device of claim 1 wherein, when the windshield defroster device is held by the handle and slid over the windshield of an automobile which has accumulated ice, the heat from the water held within the main body of the device melts the ice in a very short period of time.
